(19) United States
(12) Patent Application Publication
(10) Pub. No.: US 2010/0235723 A1
(43) Pub. Date: Sep. 16, 2010

(54) ELECTRONIC APPARATUS HAVING ELECTRONIC DICTIONARY FUNCTION

(75) Inventor: Daisuke NAKAJIMA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 12/719,459

(22) Filed: Mar. 8, 2010

(30) Foreign Application Priority Data
Mar. 10, 2009 (JP) P2009-055290

(51) Int. Cl. G06F 3/14; G06F 17/20

(52) U.S. Cl. 715/205; 715/259

(57) ABSTRACT

An electronic apparatus includes: a display device; an input unit; a dictionary storage; and a link destination display section configured to control the display device to display explanatory information being correlated with a passage being displayed on the display device based on link information that correlates the explanatory information as a link destination and the passage as a link source when the passage is selected in accordance with the user operation.

### CROSS-REFERENCE TO THE RELATED APPLICATION(S)

The present application is based upon and claims priority from prior Japanese Patent Application No. 2009-055920, filed on Mar. 10, 2009, the entire contents of which are incorporated herein by reference.

### BACKGROUND

1. Field

The present invention relates to an electronic apparatus having electronic dictionary function and a computer readable medium containing a program for displaying electronic dictionary.

2. Description of the Related Art

Conventionally, an electronic apparatus having an electronic dictionary function, such as a handheld electronic dictionary, includes a dictionary database in which head-words and explanatory information of the head-words are stored while being correlated with each other, and is configured so that explanatory information of a head-word corresponding to input characters is read out from the dictionary database, and the head-word and the explanatory information are displayed on a display device.

Recently, such an electronic apparatus is provided with a so-called jump function. The jump function is a function of, when the user selects a word of a displayed text such as explanatory information, causing explanatory information of a head-word corresponding to the word to be displayed. An example of such apparatus is disclosed in, for example, JP-A-2006-092004.

Examples of known forms of the jump function are an address jump and a super jump.

In the address jump, a link destination which is preset at shipment is displayed as a jump destination. For example, a case where, in explanatory information of a certain head-word, idioms including the head-word are listed, and explanatory information is preset in each idiom portion as a link destination will be considered. When the user selects one idiom portion from the displayed text, the idiom (head-word) and explanatory information thereof are displayed.

By contrast, in the super jump, a word which is the jump target is searched in a dictionary database which is selected by user, and a head-word corresponding to the word and its explanatory information are displayed. When the user selects a word of the jump target from a displayed text and then selects a dictionary database of the search destination, for example, the word is searched in the selected dictionary database, and a head-word corresponding to the word and its explanatory information are displayed.

However, there is a case where the user cannot easily use the above-described jump function.

Specifically, in the address jump, the jump destination is set to only a screen which is preset as the link destination at shipment. Occasionally, therefore, explanatory information which the user wants to know cannot be displayed.

By contrast, in the super jump, characters which can be selected to constitute a word of the jump target are limited to those which can constitute a head-word in the dictionary database, such as hiragana, katakana, kanji, and alphabets. The dictionary database of the search destination must be selected from a preset dictionary group, and hence it sometimes occurs that explanatory information in the dictionary database which the user wants to use cannot be displayed. Moreover, the display screen of the jump destination is configured by the beginning portion of the explanatory information of the head-word. Therefore, there is a case where explanatory information which the user wants to know cannot be displayed.

### SUMMARY

One of objects of the present invention is to provide an electronic apparatus which can be easily used by the user as compared to a conventional one, and a computer readable medium containing a program for displaying electronic dictionary.

According to a first aspect of the present invention, there is provided an electronic apparatus including: a display device; an input unit configured to accept a user operation input by a user, the user operation including various commands; a dictionary storage that stores at least one set of dictionary information containing a plurality of head-words and explanatory information respectively correlated to the head-words; a character string display section configured to control the display device to display a character string in accordance with the user operation; an explanatory information display section configured to control the display device to display at least a part of the explanatory information corresponding to arbitrary one of the head-words stored in the dictionary storage in accordance with the user operation; a link information storing section configured to set at least a part of the explanatory information displayed on the display device as a link destination and set a passage included in the character string displayed on the display device as a link source, the link information storing section being further configured to correlate and store the link destination and the link source as link information in accordance with the user operation; a link source display section configured to control the display device to display the passage being stored as the link source to be distinguishable from other contents displayed on the display device based on the link information; and a link destination display section configured to control the display device to display the explanatory information being correlated with the passage being displayed on the display device based on the link information when the passage is selected in accordance with the user operation.

According to a second aspect of the present invention, there is provided a computer readable medium containing a software program executable by a computer system including a display device, the software program including a sequence of instructions for causing the computer system to perform a process including: accepting a user operation input by a user, the user operation comprising various commands; storing at least one set of dictionary information containing a plurality of head-words and explanatory information respectively correlated to the head-words; controlling the display device to display a character string in accordance with the user operation; controlling the display device to display at least apart of the explanatory information corresponding to arbitrary one of the head-words stored in the dictionary storage in accordance with the user operation; setting at least a part of the explanatory information displayed on the display device as a link destination while setting a passage included in the character string displayed on the display device as a link source; correlating and storing the link destination and the link source as link information in accordance with the user operation; controlling the display device to display the passage being stored as the link source to be distinguishable from other contents displayed on the display device based on the link information; and controlling the display device to display the explanatory information being correlated with the passage being displayed on the display device based on the link information when the passage is selected in accordance with the user operation.

According to a third aspect of the present invention, there is provided an electronic apparatus including: a display device; an input unit configured to accept a user operation input by a user, the user operation including various commands; a dictionary storage that stores at least one set of dictionary information containing a plurality of head-words and explanatory information respectively correlated to the head-words; and a processor configured to: control the display device to display a character string in accordance with the user operation; control the display device to display at least a part of the explanatory information corresponding to arbitrary one of the head-words stored in the dictionary storage in accordance with the user operation; set at least a part of the explanatory information displayed on the display device as a link destination and set a passage included in the character string displayed on the display device as a link source; correlate and store the link destination and the link source as link information in accordance with the user operation; control the display device to display the passage being stored as the link source to be distinguishable from other contents displayed on the display device based on the link information; and control the display device to display the explanatory information being correlated with the passage being displayed on the display device based on the link information when the passage is selected in accordance with the user operation.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a plan view showing an overview of an electronic dictionary.

FIG. 2 is a block diagram showing the internal configuration of the electronic dictionary.

FIGS. 3A and 3B are views showing the data configuration of a dictionary database, and FIG. 3C is a view showing the data configuration of an original link table.

FIG. 4 is a flowchart showing an original link producing process.

FIG. 5 is a flowchart showing an original link operating process.

FIGS. 6A to 6D are views showing display contents of a main display device.

FIGS. 7A to 7D are views showing display contents of the main display device.

FIGS. 8A to 8E are views showing display contents of the main display device.

### DETAILED DESCRIPTION

An embodiment according to the present invention will be described in detail with reference to the accompanying drawings. The scope of the claimed invention should not be limited to the examples illustrated in the drawings and those described below.

Hereinafter, an embodiment in which the electronic apparatus of the invention is applied to a handheld electronic dictionary will be described in detail with reference to the drawings.

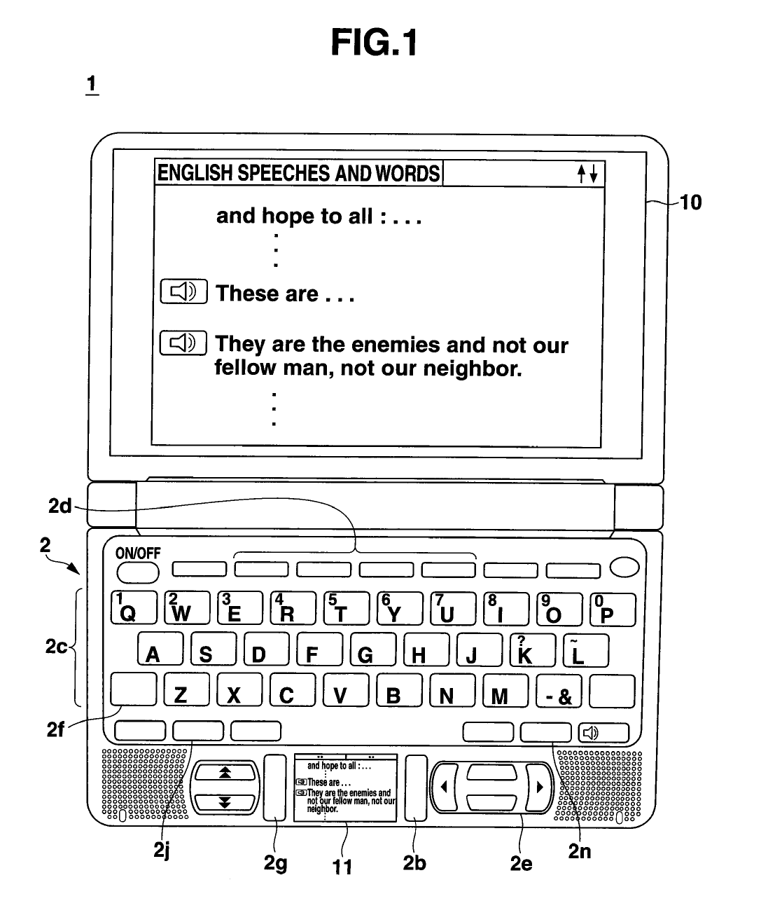

FIG. 1 is a plan view of the handheld electronic dictionary 1.

As shown in the figure, the handheld electronic dictionary 1 is provided with a main display device 10, a sub display device 11, and a key group 2.

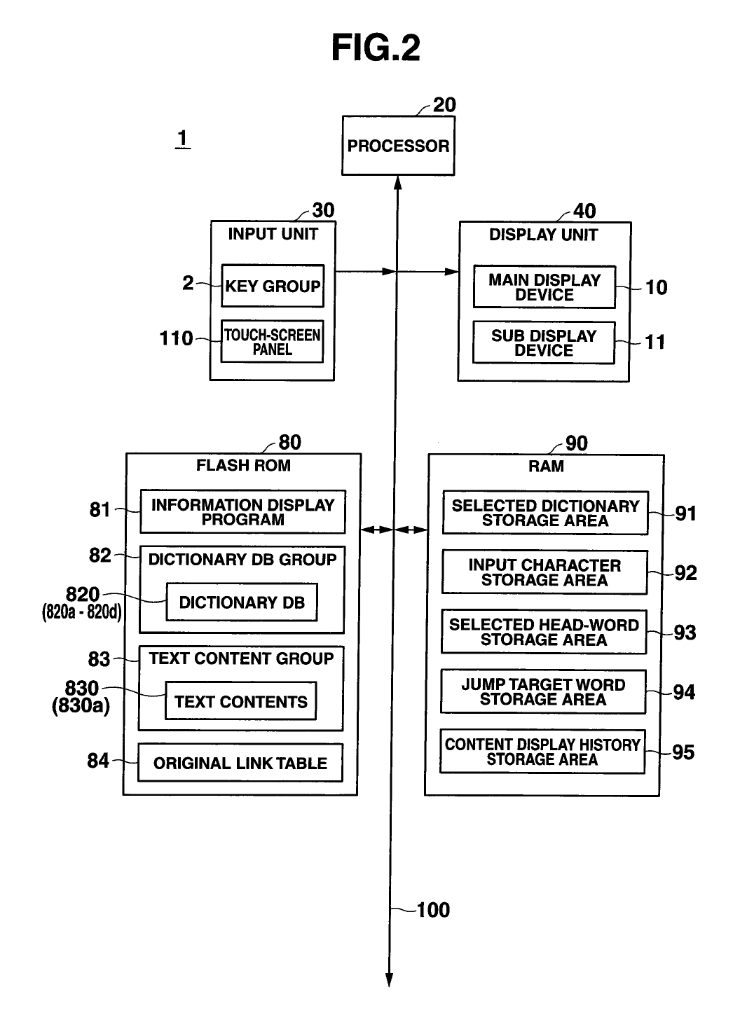

The main display device 10 and the sub display device 11 are portions which display characters, symbols, and the like corresponding to an operation of the user on the key group 2, and various data, and are configured by an LCD (Liquid Crystal Display), an ELD (Electronic Luminescent Display), or the like. In the embodiment, the sub display device 11 is assumed to be formed integrally with a so-called touch-screen panel 110 (see FIG. 2) so that, when the surface is pressed, an input operation corresponding to the pressed position is enabled.

The key group 2 has various keys which receive from the user an operation for operating the handheld electronic dictionary 1. The key group 2 is provided with various keys including a translate/enter key 2b, character keys 2c, a dictionary selection key 2d, cursor keys 2e, a shift key 2f, a return key 2g, a compound word key 2j, and a jump key 2n.

The translate/enter key 2b is used in execution of a searching process, determination of a head-word, etc. The character keys 2c are used in inputting of characters by the user, and the like, and, in the embodiment, include “A” to “Z” keys. The dictionary selection key 2d is used for selecting one of dictionary databases 820, . . . (see FIG. 2) which will be described later.

The cursor keys 2e are used for moving an inversion display position in a screen, i.e., a cursor position, and the like, and, in the embodiment, can designate the up, down, right, and left directions. The shift key 2f is used for, for example, setting a Japanese word as a search target. The return key 2g is used for, for example, returning to the previously displayed screen. The compound word key 2j is a key which is pressed in the case where an idiom/compound word containing a selected head-word is to be displayed.

The jump key 2n is used for activating the jump function. In the embodiment, the jump function means the so-called super jump function in which, when the user selects a word in a displayed text (hereinafter, such a word is referred to a jump target word), a head-word corresponding to the jump target word is searched in a dictionary of the jump destination (search destination).

An internal configuration of the handheld electronic dictionary 1 will be described. FIG. 2 is a block diagram showing the internal configuration of the handheld electronic dictionary 1.

As shown in the figure, the handheld electronic dictionary 1 includes a display unit 40, an input unit 30, a processor (Central Processing Unit: CPU) 20, a flash ROM (Read Only Memory) 80, and a RAM (Random Access Memory) 90. Each of the components are configured so as to be able to perform data communication with one another through a bus 100.

The display unit 40 includes the main display device 10 and the sub display device 11, and is configured so that, based on a display signal supplied from the processor 20, various information is displayed on the main display device 10 and the sub display device 11.

The input unit 30 includes the key group 2 and the touch-screen panel 110, and is configured so as to output a signal which corresponds to a pressed key or a pressed position in the touch-screen panel 110, to the processor 20.

The processor 20 is configured so as to execute a process based on a predetermined program in accordance with input instructions to perform giving of instructions to the functional portions, data transfer, and the like, thereby overall controlling the handheld electronic dictionary 1. Specifically, the processor 20 reads out various programs stored in the flash ROM 80 in accordance with an operation signal supplied from the input unit 30, and the like, and executes processes according to the programs. Then, the processor 20 stores results of the processes into the RAM 90, and controls the display unit 40 so as to appropriately output the process results.

The flash ROM 80 is a memory which stores programs and data for realizing various functions of the handheld electronic dictionary 1. In the embodiment, the flash ROM 80 stores an information display program 81 related to the invention, a dictionary database group 82, a text content group 83, an original link table 84, etc.

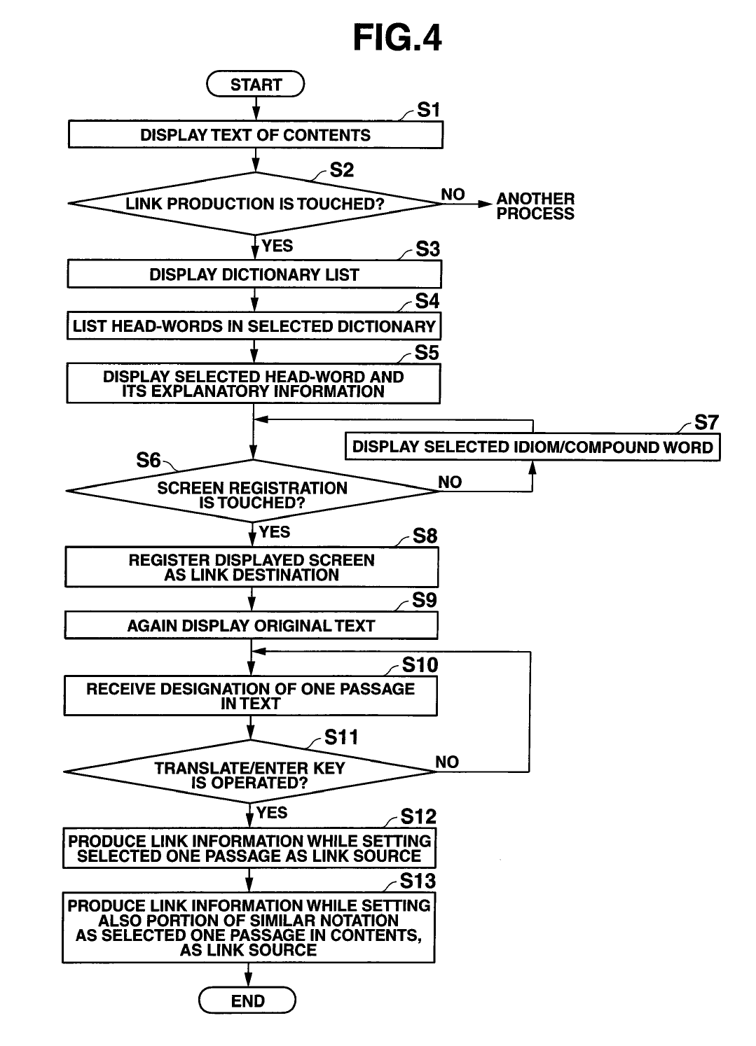

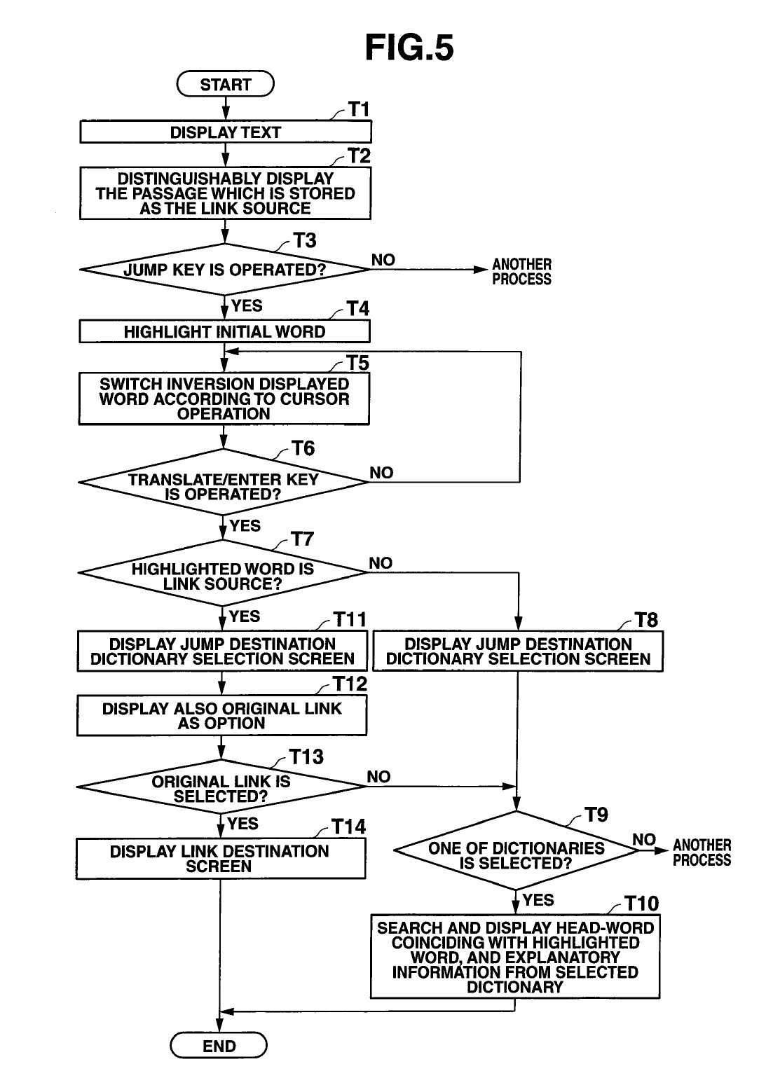

The information display program 81 is a program for causing the processor 20 to execute, for example, an original link producing process (see FIG. 4) and original link operating process (see FIG. 5) which will be described later. The original link producing process means a process for enabling the user to produce an original link while setting arbitrary display contents as the jump source or the jump destination. The original link operating process means a process for displaying display contents the jump destination from those of the jump source on the basis of the original link produced by the user.

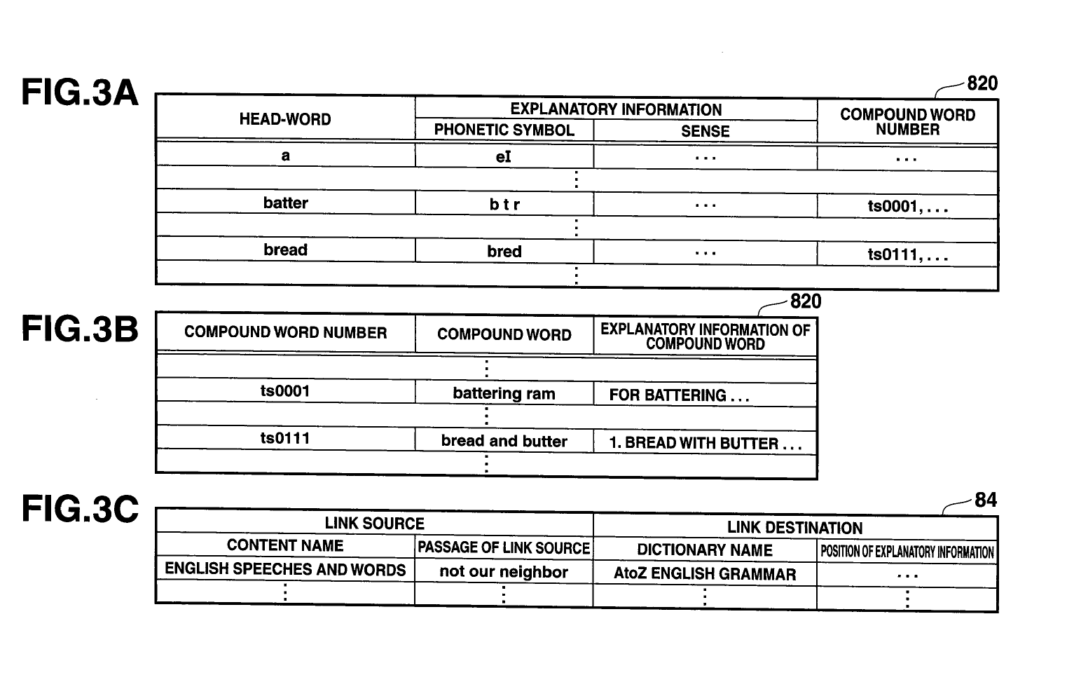

The dictionary database group 82 has the plurality of dictionary databases 820, . . . In the embodiment, the group has a dictionary database 820a of “ABC English-Japanese Dictionary”, a dictionary database 820b of “XYZ English-Japanese Dictionary”, a dictionary database 820c of “English Thesaurus”, a dictionary database 820d of “AtoZ English Grammar”, etc. In these dictionary databases 820, . . . , as an example shown in FIG. 3A, for each of a plurality of head-words, explanatory information configured by the phonetic symbols and sense of the head-word, a compound word number for identifying an idiom/compound word containing the head-word, and the like are stored while being correlated with the head-word. In each of the dictionary databases 820, . . . , as an example shown in FIG. 3B, a table in which an idiom/compound word and explanatory information of the idiom/compound word are correlated with the compound word number, and the like is stored.

The text content group 83 has a plurality of text contents 830. In the embodiment, the group has a text content 830a of “English Speeches and Words”, etc.

The original link table 84 stores a passage of the link source (jump source) which is arbitrarily set by the user in the original link producing process (see FIG. 4) described later, while being correlated with display contents of the link destination (jump destination). Specifically, as shown in, for example, FIG. 3C, in the original link table 84, the content name of a text content 830 of the link source, a passage of the link source in the text content 830, the dictionary name of a dictionary database 820 of the link destination, and the position data of explanatory information of the link destination in the dictionary database 820 are correlated with one another, and accumulatively stored as link information. In the original link table 84, furthermore, the content name of a text content 830 of each link source, an inflection passage in which a word in the passage of the link source is inflected, the dictionary name of a dictionary database 820 of the link destination corresponding to the passage of the link source, and the position data of explanatory information of the link destination in the dictionary database 820 are correlated with one another, and stored as link information.

The one passage may be configured only by a single word. In the above, for example, “a word in the passage of the link source is inflected” means: coupling of constituent words by a hyphen; substitution of a constituent word which is a verb, among the root form, the past form, the past participle form, and the declension form; substitution of a countable noun among the singular form and the plural form; substitution of a personal pronoun among the nominative case, the possessive case, the objective case, the possessive pronoun, and the reflexive pronoun; or substitution of a constituent word which is an adjective, among the root form, the comparative form, and the superlative form. As a method of changing a word to obtain an inflection passage as described above, a conventionally known method such as that in which a table correlatively storing inflected wards with each word is referred may be used.

The RAM 90 includes storage areas which temporarily store various programs to be executed by the processor 20, data related to execution of the programs, etc. In the embodiment, the RAM 90 includes a selected dictionary storage area 91, an input character storage area 92, a selected head-word storage area 93, a jump target word storage area 94, and a content display history storage area 95.

In the selected dictionary storage area 91, the identification information (dictionary name) of the dictionary database 820 which is selected by the user as the search target of a head-word is stored. In the input character storage area 92, input characters which are input by the user are stored. In the selected head-word storage area 93, a selected head-word which is selected and selected by the user as a head-word that is a target of dictionary search is stored. In the embodiment, a selected head-word can be selected from a list of head-words which are read out from the dictionary database in alphabetical order or in the order of the Japanese syllabary so as to prefix match with the input characters or selected characters. In the jump target word storage area 94, a jump target word is stored. In the content display history storage area 95, the content name of the text content 830 which is displayed last time, and the position data of the displayed portion which is displayed last time are stored.

The original link producing process in the operations of the handheld electronic dictionary 1 will be described with reference to FIG. 4.

FIG. 4 is a flowchart showing the flow of the original link producing process in which the processor 20 reads out and executes the information display program 81.

As shown in the figure, when the user first presses the key group 2 to select one of the text contents 830 from the text content group 83, the processor 20 controls the main display device 10 so as to display the text content 830 (step S1).

Next, the processor 20 controls the sub display device 11 so as to display addition and registration buttons (not shown) for an original link, and determines whether the addition button for an original link is touched by the user or not (step S2).

If it is determined in step S2 that the addition button is not touched by the user (step S2: No), the processor 20 proceeds to another process. If it is determined that the addition button is touched by the user (step S2: Yes), the display contents of the text contents 830 at this timing is stored into the content display history storage area 95, and then the dictionary name list of the dictionary databases 820 is then displayed on the main display device 10 (step S3) to request the user to select one of the dictionary databases 820 as the jump destination (link destination).

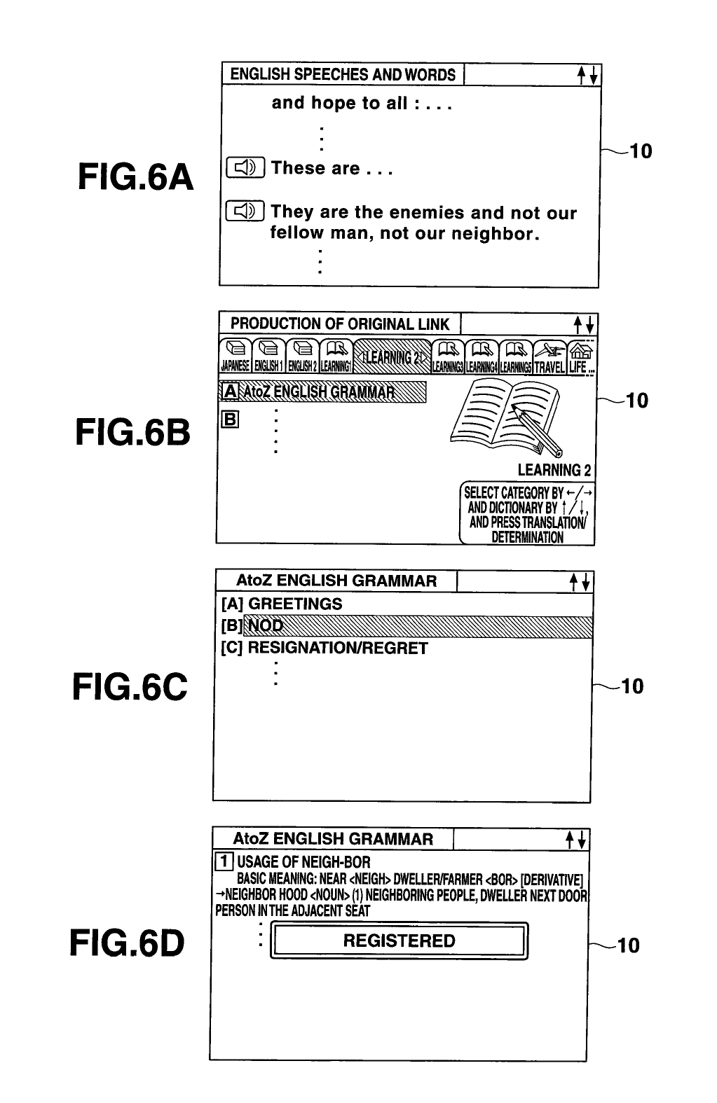

Next, when the user selects one of the dictionary databases 820, the processor 20 stores the dictionary name of the selected dictionary database 820 into the selected dictionary storage area 91, and displays head-words in the dictionary database 820 on the main display device 10 in the form of a list (step S4), thereby requesting the user to select one of the head-words as the jump destination (link destination). Alternatively, the user may input a search character string to select the head-word, or, as shown in FIG. 6C which will be described later, the head-word may be selected in accordance with the classification in the dictionary database 820.

Next, when the user selects one of the head-words, the processor 20 searches (detects) the selected head-word and the explanatory information thereof from the selected dictionary database 820, and displays them on the main display device 10 (step S5). In the case where the displayed explanatory information fails to fit into the display region of the main display device 10, the processor 20 scrolls the display contents in accordance with a user's operation on the cursor keys 2e, so that part of the explanatory information is displayed on the main display device 10.

Next, the processor 20 determines whether the user touches the registration button on the sub display device 11 or not (step S6). If the processor determines that the user does not touch the registration button (step S6: No), i.e., if the processor determines that the user operates the compound word key 2j or the like to perform the operation of displaying an idiom/compound word or the like in the explanatory information, the explanatory information of the selected idiom/compound word is displayed (step S7), and then the processor 20 proceeds with the process to step S6. Also in step S7, in the case where the displayed explanatory information fails to fit into the display region of the main display device 10, the processor 20 scrolls the display contents in accordance with an operation on the cursor keys 2e, so that part of the explanatory information is displayed on the main display device 10.

By contrast, if the processor determines in step S6 that the user touches the registration button (step S6: Yes), the processor 20 sets the dictionary name of the dictionary database 820 which is displayed on the main display device 10, and the position of the displayed explanatory information as the jump destination (link destination), stores them into the original link table 84, and displays the storing on the main display device 10 (step S8).

Next, the processor 20 controls the main display device 10 so as to again display the display contents of the text content 830 which are displayed in steps S1 and S2, on the basis of the content display history storage area 95 (step S9), and requests the user to designate one arbitrary passage in the displayed character string (step S10).

Then, the processor 20 determines whether the translate/enter key 2b is operated or not (step S11). If the processor determines that the key is not operated (step S11: No), the processor 20 proceeds with the process to step S10.

By contrast, if the processor determines in step S11 that the translate/enter key 2b is operated (step S11: Yes), the processor 20 sets the content name of the displayed text content 830, and the selected passage in the text content 830 as the link source, stores them as link information into the original link table 84 while being correlated with the dictionary name and position of the explanatory information which are set in step S8, and displays the storing on the main display device 10 (step S12).

Next, the processor 20 detects an inflection passage in which a word in the passage of the link source is inflected, from the displayed text content 830, sets the contend name of the displayed text content 830 and the detected inflection passage as the link source, and stores them as link information into the original link table 84 while being correlated with the dictionary name and position of the explanatory information which are set in step S8 (step S13). Then, the original link producing process is terminated.

Next, the original link operating process in the operations of the handheld electronic dictionary 1 will be described.

FIG. 5 is a flowchart showing the flow of the original link operating process in which the processor 20 reads out and executes the information display program 81.

As shown in the figure, when the user presses the key group 2 and one of the text contents 830 from the text content group 83 is displayed on the main display device 10 (step T1), the processor 20 distinguishably displays the passage (including the inflection passage) which is stored as the link source, on the basis of the link information in the original link table 84 (step T2). In the embodiment, the distinguishable display is performed by underscoring the characters. Alternatively, the distinguishable display may be performed in another manner, for example, by displaying the characters in boldface.

Next, the processor 20 determines whether the user operates the jump key 2n or not (step T3), and, if the processor determines that the user does not operate the key (step T3: No), the processor 20 proceeds with another process.

By contrast, if the processor determines in step T3 that the user operates the jump key 2n (step T3: Yes), the processor 20 inversion displays the initial word of the display contents of the main display device 10, by means of the cursor (step T4), and then switches the cursor position (the inversion displayed word) in accordance with an operation of the cursor keys 2e by the user (step T5).

Next, the processor 20 determines whether the user operates the translate/enter key 2b or not (step T6), and, if the processor determines that the user does not operate the key (step T6: No), the processor 20 proceeds with the process to step T5.

If the processor determines in step T6 that the user operates the translate/enter key 2b (step T6: Yes), the processor 20 determines whether the word which is inversion displayed at this timing is a word which is included in the passage of the link source or not (step T7).

If the processor 20 determines in step T7 that the inversion displayed word is not a word which is included in the passage of the link source (step T7: No), the processor 20 stores the inversion displayed word as the jump target word into the jump target word storage area 94, and then displays the dictionary name list of the dictionary databases 820 which contain the head-word corresponding to the jump target word, on the main display device 10 (step T8) to request the user to select one of the dictionary databases 820 as the jump destination.

Next, the processor 20 determines whether one of the dictionary names is selected or not (step T9), and, if the processor determines that none of the dictionary names is selected (step T9: No), the processor 20 proceeds with another process. By contrast, if the processor determines that that one of the dictionary names is selected (step T9: Yes), the processor stores the dictionary name of the selected dictionary database 820 into the selected dictionary storage area 91, and searches (detects) the explanatory information of the head-word corresponding to the jump target word, from the selected dictionary database 820 to display the information on the main display device 10 (step T10). Then, the original link operating process is terminated.

If the processor determines in step T7 that the inversion displayed word is a word which is included in the passage of the link source (step T7: Yes), the processor 20 stores the inversion displayed word as the jump target word into the jump target word storage area 94, then displays the dictionary name list of the dictionary databases 820 which contain the head-word corresponding to the jump target word, on the main display device 10 (step T11), and displays also the original link produced in the above-described original link producing process, as an option on the main display device 10 (step T12), thereby requesting the user to select either of the dictionary databases 820 and the original link as the jump destination.

Next, the processor 20 determines whether the original link is selected or not (step T13), and, if the processor determines that the link is not selected (step T13: No), the processor 20 proceeds with the process to above-described step T9.

If the processor determines in step T13 that the original link is selected (step T13: Yes), the processor displays the explanatory information of the link destination in the dictionary database 820 of the link destination corresponding to the passage (including the inflection passage) of the link source, on the main display device 10 (step T14). Then, the original link operating process is terminated.

Then, the original link producing process and original link operating process that have been described above will be specifically described with reference to FIGS. 6 to 8.

### Operation Example 1

First, as shown in FIGS. 6A and 6B, when the user selects the text content 830a of “English Speeches and Words” from the text content group 83, part of the text content 830a is displayed (step S1), and the addition button for the original link is then touched (step S2: Yes), the dictionary name list of the dictionary databases 820 is displayed on the main display device 10 (step S3).

Next, as shown in FIGS. 6C and 6D, when the explanatory information of head-word “neighbor” is searched from the dictionary database 820d of “AtoZ English Grammar” (step S5), and the registration button is then touched (step S6: Yes), the dictionary name “AtoZ English Grammar” of the dictionary database 820d, and the position of displayed explanatory information “Usage of neigh-bor . . . ” are then stored as the jump destination (link destination) into the original link table 84, and the storing is displayed on the main display device 10 (step S8).

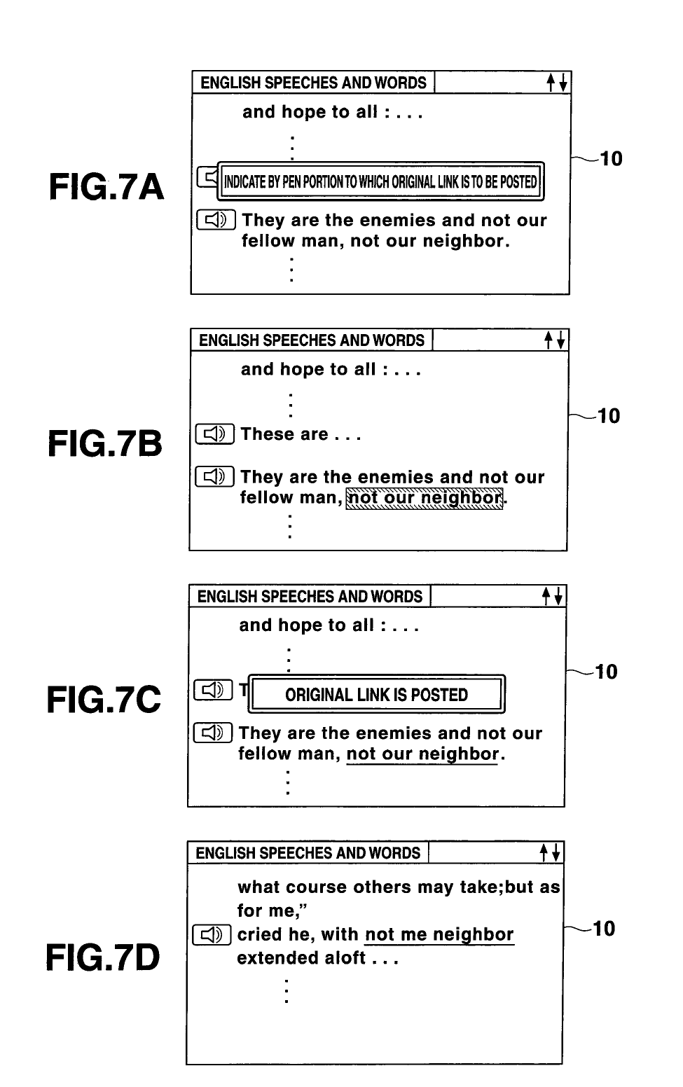

Next, as shown in FIG. 7A, the display contents of the text content 830a of “English Speeches and Words” which are displayed insteps S1 and S2 are again displayed on the main display device 10 (step S9), and the request to the user for designating one passage of the displayed character string by means of the cursor is displayed on the main display device 10 (step S10).

Next, as shown in FIGS. 7B and 7C, when the one passage “not our neighbor” in the text content 830a of “English Speeches and Words” is selected as the link source, and the translate/enter key 2b is operated (step S11: Yes), the content name “English Speeches and Words” of the displayed text content 830a, and the one passage “not our neighbor” selected in the text content 830a are set as the link source, and stored while correlated with the dictionary name “AtoZ English Grammar” of the link destination and the position of the explanatory information “Usage of neigh-bor . . . ”, and the storing is displayed on the main display device 10 (step S12). Furthermore, the content name “English Speeches and Words” of the displayed text content 830a, and inflection passage “not my neighbor” of the one passage “not our neighbor” selected in the text content 830a are set as the link source, and stored while correlated with the dictionary name “AtoZ English Grammar” of the link destination and the position of the explanatory information “Usage of neigh-bor . . . ” (step S13).

As shown in FIG. 7D, when the text content 830a of “English Speeches and Words” is selected by the user from the text content group 83, and the text content 830a is displayed (step T1), the one passage “not our neighbor” of the link source is distinguishably displayed (step T2).

### Operation Example 2

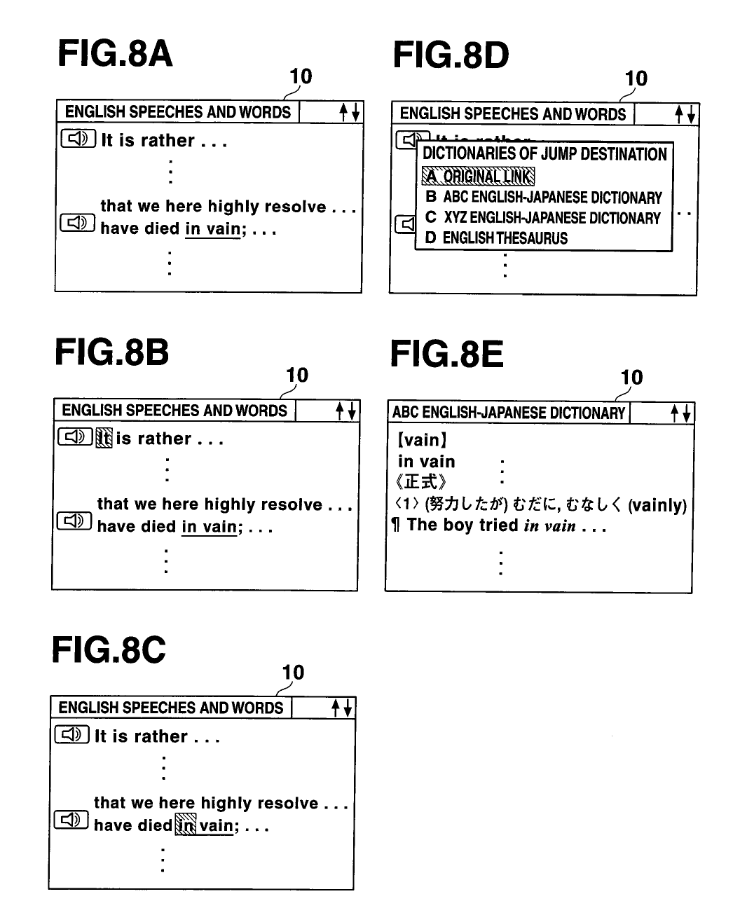

First, in a state where one passage “in vain” in the text content 830a of “English Speeches and Words” is set as the link source, and an explanatory portion of “in vain” in the explanatory information of “vain” in the dictionary database 820a of “ABC English-Japanese Dictionary” is set as the link destination, the text content 830a of “English Speeches and Words” is selected by user from the text content group 83 and displayed as shown in FIG. 8A (step T1). Then, the one passage “in vain” which is stored as the link source is distinguishably displayed (step T2).

Next, as shown in FIG. 8B, when the jump key 2n is operated (step T3: Yes), initial word “It” of the display contents of the main display device 10 is inversion displayed (step T4).

Next, as shown in FIGS. 8C and 8D, when the cursor keys 2e are operated and the cursor is moved to the inside (“in” or “vain”) of the one passage “in vain” of the link source, and the translate/enter key 2b is then operated (step T6: Yes, step T7: Yes), the dictionary names of the dictionary database 820, and the original link are displayed as options on the main display device 10 (steps T11 and T12).

As shown in FIG. 8E, when the original link is selected (step T13: Yes), the explanatory portion of “in vain” in the dictionary database 820a of “ABC English-Japanese Dictionary” is displayed (step T14).

According to the above-described handheld electronic dictionary 1, as shown in step S12 of FIG. 4, steps T2 and T11 to T14 of FIG. 5, FIGS. 8A to 8E, and the like, when, in accordance with an operation of the user, at least part of explanatory information displayed on the display unit 40 is stored correlatively stored as a link destination, and a passage of a displayed character string is correlatively stored as a link source, the passage in the displayed contents which is stored as the link source is distinguishably displayed, and, when the passage which is distinguishably displayed is selected by an operation of the user, explanatory information of the link destination in which the passage is set as the link source is displayed. Therefore, the display contents can be switched, i.e., jump from an arbitrary passage of the link source to an arbitrary explanatory information portion of the link destination.

Unlike the conventional address jump in which the jump is can be performed only to a screen which is preset as the link destination at shipment, the display contents can be jumped to an arbitrary explanatory information portion of the link destination. Therefore, the ease of use of the user can be correspondingly improved. Unlike the conventional super jump in which characters that can be selected to constitute a word of the jump target are limited to those which can constitute a head-word in a dictionary database, such as hiragana, katakana, kanji, and alphabets, an arbitrary character string can be set to the link source (jump source), and hence the ease of use of the user can be correspondingly improved. Unlike the conventional super jump in which a dictionary database of the search destination is selected from a preset dictionary group, the display contents can be jumped to an explanatory information portion in arbitrary dictionary information of the link destination, and explanatory information in dictionary information which the user wants to use can be displayed. Therefore, the ease of use of the user can be correspondingly improved. Moreover, unlike the conventional super jump in which the display screen of the jump destination is limited to the beginning portion of the explanatory information of a head-word, the display contents can be jumped to an arbitrary explanatory information portion of the link destination, and hence the ease of use of the user can be correspondingly improved.

Therefore, the ease of use of the user can be improved as compared with the prior art.

As shown in step S13 of FIG. 4 and steps T2 and T11 to T14 of FIG. 5, one passage which is set as the link source, and an inflection passage of the one passage are distinguishably displayed as the link destination, and, when the distinguishably displayed inflection passage is selected in accordance with an operation of the user, explanatory information of the link destination in which a passage corresponding to the inflection passage is set as the link source is displayed on the basis of link information. Also from the inflection passage, in addition to the one passage which is set as the link source, therefore, the display contents can be jumped to the explanatory information of the link destination. Therefore, the ease of use of the user can be further improved.

As shown in step T13 of FIG. 5 and FIG. 8D, in the case where the distinguishably displayed passage is selected in accordance with an operation of the user, it is possible to select, in accordance with an operation of the user, one of the display in which explanatory information of the link destination in which the one passage is set as the link source is displayed, and that in which the initial word of the one passage is set as a jump target word and explanatory information of a head-word corresponding to the jump target word is displayed. Therefore, each of the original link in which the link source and the link destination are uniquely set by the user, and the conventional jump function can be used properly. Therefore, the ease of use of the user can be further improved.

In the embodiment described above, the processor 20 is configured to serves as the following sections:

(a) a character string display section configured to control the display device to display a character string in accordance with the user operation;

(b) an explanatory information display section configured to control the display device to display at least a part of the explanatory information corresponding to arbitrary one of the head-words stored in the dictionary storage in accordance with the user operation;

(c) a link information storing section configured to set at least a part of the explanatory information displayed on the display device as a link destination and set a passage included in the character string displayed on the display device as a link source, the link information storing section being further configured to correlate and store the link destination and the link source as link information in accordance with the user operation;

(d) a link source display section configured to control the display device to display the passage being stored as the link source to be distinguishable from other contents displayed on the display device based on the link information;

(e) a link destination display section configured to control the display device to display the explanatory information being correlated with the passage being displayed on the display device based on the link information when the passage is selected in accordance with the user operation;

(f) an inflection passage detecting section configured to detect an inflection passage in which a word in the passage being set as the link source is inflected;

(g) a dictionary list display section configured to, when a word in the contents displayed on the display device is selected as a jump target word in accordance with the user operation, detect dictionary information containing a head-word corresponding to the jump target word from the dictionary storage and control the display device to display a list of the dictionary information;

(h) an additional information display section configured to detect explanatory information of a head-word corresponding to the jump target word from dictionary information selected in accordance with the user operation, in the dictionary information being listed by the dictionary list display section, and to control the display device to display the explanatory information; and

(i) a display selection section configured to, when a word contained in the passage being distinguishably displayed on the display device is selected in accordance with the user operation, select, in accordance with the user operation, whether to display the explanatory information of the link destination in which the passage is set as the link source is caused by the link destination display section to be displayed on the display device, or to display the explanatory information of a head-word corresponding to the jump target word is caused by the dictionary list display section and the additional information display section to be displayed on the display device while setting a selected word as a jump target word.

However, the respective sections may be implemented in the handheld electronic dictionary 1 as any other form of hardware configuration or of software configuration.

Embodiments to which the invention can be applied are not limited to the above-described embodiment, and the embodiment can be appropriately modified in various manners without departing from the spirit and the scope of the invention.

For example, although the handheld electronic dictionary 1 has been described as the electronic apparatus of the invention, apparatuses to which the invention can be applied are not limited to such a product, but can be applied to a wide range of electronic apparatuses such as a portable telephone and a personal computer. The information display program 81 according to the invention may be stored in a device which is detachably mounted on the handheld electronic dictionary 1, such as a memory card or a Compact Disc (CD).

In the above description, an inflection passage in which a word in a passage of the link source is inflected is stored in the original link table 84, and the inflection passage of the link source is distinguishably displayed on the basis of information in the original link table 84. Alternatively, the link information of the inflection passage may not be stored in the original link table 84, and, when the text content 830 is displayed on the main display device 10 to distinguishably display one passage of the link source, an inflection passage for the one passage of the link source may be detected from the text content 830, and distinguishably displayed.

In the above description, the content name of the text content 830 of the link source is stored in the original link table 84, and the passage of the link source in the stored text content 830 is distinguishably displayed. Alternatively, the content name of the text content 830 may not be stored, and, when any one of text contents 830 is displayed, the passage of the link source may be distinguishably displayed.

In the above operation examples, the description has been made while assuming that one passage of the text content 830a of “English Speeches and Words” is set as the link source, and explanatory information of the dictionary databases 820d, 820a of “AtoZ English Grammar” and “ABC English-Japanese Dictionary” are set as the link destination. Alternatively, one passage of an English reading content may be set as the link source, and a description and idiom explanatory portion of an English dictionary may be set as the link destination; a difficult kanji characters may be set as the link source, and explanatory information of “Common Dictionary of Hard-to-read Kanji” may be set as the link destination; or one passage of a text content of “Family Medicine” may be as the link source, and the description of “Knowing Your Prescription Drugs” may be set as the link destination.

What is claimed is:

1. An electronic apparatus comprising:
a display device;
an input unit configured to accept a user operation input by a user, the user operation comprising various commands;
a dictionary storage that stores at least one set of dictionary information containing a plurality of head-words and explanatory information respectively correlated to the head-words;
a character string display section configured to control the display device to display a character string in accordance with the user operation;
an explanatory information display section configured to control the display device to display at least a part of the explanatory information corresponding to arbitrary one of the head-words stored in the dictionary storage in accordance with the user operation;
a link information storing section configured to set at least a part of the explanatory information displayed on the display device as a link destination and set a passage included in the character string displayed on the display device as a link source, the link information storing section being further configured to correlate and store the link destination and the link source as link information in accordance with the user operation;
a link source display section configured to control the display device to display the passage being stored as the link source to be distinguishable from other contents displayed on the display device based on the link information; and
a link destination display section configured to control the display device to display the explanatory information being correlated with the passage being displayed on the display device based on the link information when the passage is selected in accordance with the user operation.

2. The electronic apparatus according to claim 1 further comprising:
an inflection passage detecting section configured to detect an inflection passage in which a word in the passage being set as the link source is inflected,
wherein the link source display section is configured to control the display device to distinguishably display the passage being stored as the link source in the link information storing section and the inflection passage of the passage as the link source, and
wherein the link destination display section is configured to control the display device to display the explanatory information being set as the link destination corresponding to the inflection passage being set as the link source based on the link information when the inflection passage being distinguishably displayed on the display device is selected in accordance with the user operation.

3. The electronic apparatus according to claim 1 further comprises:
a dictionary list display section configured to, when a word in the contents displayed on the display device is selected as a jump target word in accordance with the user operation, detect dictionary information containing a head-word corresponding to the jump target word from the dictionary storage and control the display device to display a list of the dictionary information;
an additional information display section configured to detect explanatory information of a head-word corresponding to the jump target word from dictionary information selected in accordance with the user operation, in the dictionary information being listed by the dictionary list display section, and to control the display device to display the explanatory information; and
a display selection section configured to, when a word contained in the passage being distinguishably displayed on the display device is selected in accordance with the user operation, select, in accordance with the user operation, whether to display the explanatory information of the link destination in which the passage is set as the link source is caused by the link destination display section to be displayed on the display device, or to display the explanatory information of a head-word corresponding to the jump target word is caused by the dictionary list display section and the additional information display section to be displayed on the display device while setting a selected word as a jump target word.

4. A computer readable medium containing a software program executable by a computer system comprising a display device, the software program comprising a sequence of instructions for causing the computer system to perform a process comprising:
accepting a user operation input by a user, the user operation comprising various commands;
storing at least one set of dictionary information containing a plurality of head-words and explanatory information respectively correlated to the head-words;
controlling the display device to display a character string in accordance with the user operation;
controlling the display device to display at least a part of the explanatory information corresponding to arbitrary one of the head-words stored in the dictionary storage in accordance with the user operation;
setting at least a part of the explanatory information displayed on the display device as a link destination while setting a passage included in the character string displayed on the display device as a link source;
correlating and storing the link destination and the link source as link information in accordance with the user operation;
controlling the display device to display the passage being stored as the link source to be distinguishable from other contents displayed on the display device based on the link information; and
controlling the display device to display the explanatory information being correlated with the passage being displayed on the display device based on the link information when the passage is selected in accordance with the user operation.

5. An electronic apparatus comprising:
a display device;
an input unit configured to accept a user operation input by a user, the user operation comprising various commands;
a dictionary storage that stores at least one set of dictionary information containing a plurality of head-words and explanatory information respectively correlated to the head-words; and
a processor configured to:
control the display device to display a character string in accordance with the user operation;
control the display device to display at least a part of the explanatory information corresponding to arbitrary one of the head-words stored in the dictionary storage in accordance with the user operation;
set at least a part of the explanatory information displayed on the display device as a link destination and set a passage included in the character string displayed on the display device as a link source;
correlate and store the link destination and the link source as link information in accordance with the user operation;
control the display device to display the passage being stored as the link source to be distinguishable from other contents displayed on the display device based on the link information; and
control the display device to display the explanatory information being correlated with the passage being displayed on the display device based on the link information when the passage is selected in accordance with the user operation.
